(19) United States
(12) Patent Application Publication
(10) Pub. No.: US 2008/0152771 A1
(43) Pub. Date: Jun. 26, 2008

(54) METHOD FOR PRODUCING A SENSORY-STIMULATING EFFECT

(76) Inventors: VINCENT SCALISI, MISSISSAUGA (CA); MARVIN HEUER, MISSISSAUGA (CA); KEN CLEMENT, MISSISSAUGA (CA)

Correspondence Address: TORYS LLP, 79 WELLINGTON ST. WEST, SUITE 3000, TORONTO, ON, M5K 1N2, omitted

(21) Appl. No.: 11/614,246

(22) Filed: Dec. 21, 2006

(51) Int. Cl. A23L 1/29

(52) U.S. Cl. 426/390

(57) ABSTRACT

The present invention relates to a method for producing a sensory stimulating effect upon the opening of a vessel containing a nutritional or dietary supplement. The sensory stimulating effect occurs each time the vessel is opened and without shaking or disturbance of the vessel prior to said opening. At least some of the nutritional or dietary supplement is fine-milled to produce particles of an effective size and an effective weight to provide the desired effect upon opening the vessel.

### FIELD OF THE INVENTION

The present invention relates to a method for producing a sensory-stimulating effect upon the opening of a containment vessel, hereinafter referred to as the “container”, containing a nutritional or dietary supplement, wherein the sensory-stimulating effect occurs each time the containment vessel is opened and without shaking or disturbance of the containment vessel prior to opening.

### BACKGROUND OF THE INVENTION

The nutritional and dietary supplement industry produces a plethora of marketable products every year. These products include various compositions such as protein powders, creatine-based products, and amino acids geared products, just to name a few. These products and product formulations are typically indistinguishable from one another based on sensory cues and visual properties alone. For example, most powdered based formulations have a bland yellowish color and flour like texture. Furthermore, these powders, once opened or outside the product container are typically indistinguishable from the visual properties and sensory effects of other powdered based products. The bland appearance and lack of sensory-stimulating effects of these products is not very enticing to a consumer.

Naturally, the nutritional and dietary supplement industry's main focus is to distinguish the products through improved product composition and formulations. However, improved formulations and compositions still lack the necessary sensory-stimulating effect to entice and excite a consumer's sensory system. For the most part, enticement and excitement of a consumer is provided though means of creative packaging, advertising, marketing, and promotions. However, the same problem arises once the consumer brings the product home and opens the product container. Once more, the consumer is confronted with the bland appearance and little if any sensory-stimulating effect upon the opening of the container.

The present invention seeks to provide sensory-stimulation effect to a user, of a composition, wherein the sensory stimulating effect occurs each time a container comprising the composition is opened.

### SUMMARY OF THE INVENTION

The foregoing needs and other needs and objectives that will become apparent for the following description are achieved in the present invention, which comprises a method of producing a sensory stimulating effect of a composition upon the opening of a container. Within the container, one or more ingredients are supplied in a powdered format wherein at least a portion of the powdered particles have an effective size and effective weight so as to disperse upon the opening the container, providing a substantially uniform and randomly-dispersed sensory effect.

According to one embodiment, a user is afforded a sensory-stimulating effect upon opening a containment vessel containing a powdered nutritional or dietary supplement. An aspect of the present invention is that the aforementioned sensory-stimulating effect is repeated for subsequent openings of the container. It is yet a further aspect of the invention that the sensory-stimulating effect is provided in the absence of undue agitation or disruption of the container contents.

In another embodiment of the invention, the powdered nutritional or dietary supplement or portion thereof is colored such that the sensory-stimulating effect provided to the user is afforded said color.

In yet another embodiment of the invention the powdered nutritional or dietary supplement is provided with a scent such that sensory-stimulating effect is provided with a scent.

### DETAILED DESCRIPTION OF THE INVENTION

In the following description, for the purposes of explanation, numerous specific details are set forth in order to provide a thorough understanding of the present invention. It will be apparent, however, to one of ordinary skill in the art that the present invention may be practiced without these specific details.

Presently, the nutritional and dietary supplement industry produces and markets several compositions wherein a powdered format is preferred. The packaging and composition of nutritional or dietary supplements presently distributed, marketed, and sold within the industry provide little or no sensory-stimulation to a user. As such, the present invention seeks to engage the user by way of a method employing a composition to provide sensory-stimulation and enjoyment upon opening a container comprising a nutritional or dietary supplement.

In one embodiment of the invention an effective amount of the claimed composition is provided with particles of an effective size and of an effective weight such that the powdered nutritional or dietary composition will provide a sensory-stimulating effect to a user upon opening a container.

According to a first aspect of the invention a method and composition is provided such that a user upon opening a container comprising a powdered nutritional or dietary supplement is provided with a sensory-stimulating effect.

In a second aspect of the present invention the aforementioned sensory-stimulating effect is repeated for subsequent openings of the container.

It is a further aspect of the invention that the sensory-stimulating effect is provided in the absence of undue agitation or disruption of the container contents.

In another embodiment of the invention, the composition or portion of the composition is colored such that the sensory-stimulating effect provided to a user is afforded said color.

In yet another embodiment of the invention, the composition is provided with a scent such that an olfactory sensory-stimulating effect upon opening the container, for example menthol scent or lemon scent. Additional scents include but are not limited to pine, citrus, fruit-punch, chocolate, strawberry, vanilla and cinnamon.

As used herein, the term “container” refers to a containment vessel, wherein the containment vessel is equipped with a closing means.

As used herein, the term “sensory-stimulation” refers to the evocation of one or all of an individual's perception modalities. Perception modalities may be selected from the group consisting of olfactory stimulation, visual stimulation and gustatory stimulation. The sensory-stimulation may further, in the interests of the present invention, be defined as any stimulus within an individual's given receptive fields having sufficient abilities to evoke the signal transduction of a sensory receptor causing neuronal impulse generation and conduction integration at the central nervous system such that sensation and perception of the stimulus is achieved.

As used herein, the term “visual effect” refers to substantially uniform appearance of randomly-dispersed airborne fine-milled particles. Said visual effect is apparent to a user as a vapor-like, smoke-like, cloud-like, fog-like, or mist-like formation.

As used herein, the term “particle size” refers to the diameter of the particle. In one embodiment, at least 80% of the particles in a given sample will be in the specified particle size range, and in another embodiment, at least 90% of the particles in a given sample will have the specified particle size range.

### Particle Micronization

According to one aspect of the present invention the method utilizes fine-milled particles and the related properties thereof to achieve the sensory-stimulating effect. In embodiments of the present invention, at least a portion of the powdered nutritional or dietary supplement is fine-milled.

As used herein, the terms “fine-milled” and/or “fine-milling” refers to the process of micronization. Micronization is a mechanical process which involves the application of force to a particle, thereby resulting in a reduction in the size of said particle.

U.S. Provisional Application No. 60/776,325 entitled: “Compositions and Method for Increasing Bioavailability of Compositions for Performance Improvement”, which is herein fully incorporated by reference, discloses a method of improving the absorption, palatability, taste, texture and bioavailability of compounds by increasing the solubility.

Dry milling or nanosuspensions are often made by air-jet milling and wet-milling in pearl mills and rotor-stator mills are used in the micronization process.

Methods of milling particles can be those such as hammer mills, cryogenic hammer mills, fluid and air jet milling, jaw crushing, and high-pressure dispersion milling. These are methods of medialess milling. Hammer milling produces particles of typically 30-500 microns. At ambient temperatures, rotating hammers which strike the particles repeatedly reduce the particle size to a point where they can pass through a screen. If required, the process can also be done at lower temperatures. During the process of jet milling, particles are suspended in flowing streams of air where they are targeted at either themselves or a stationary target. This results in a fine grind wherein a particle size is typically 1-10 microns.

The preferred type of medialess milling that can be employed is high pressure dispersion milling. In this type of particle milling dispersions are pressurized to 10,000-50,000 psi. At this point, the pressure is rapidly released. This release in pressure causes cavitation and grinding. Particles of 0.5 to 1 micron are typically produced via this method.

In the process known as media milling, balls, pebbles or other media such as sand are added to the material to be ground in order to reduce particle size. The collisions of the media with material to be ground results in the breakage of the particles. Using media milling, particles can be milled to an average size of 0.1 micron with relative ease. Through control of the grinding time and force with which the material is ground, virtually any particle size can be obtained. A media mill can be used with or without any liquids additives, although water or other solvents are commonly used to produce the finest particles.

Acceptable fine-milling technique result in fine-milled particles having an average particle size of between from about 50 microns to about 2 microns. The reduction in size of the particles increases the surface area-to-volume ratio of each particle.

The reduction in particle size also concomitantly imparts a reduced weight to each particle. This reduction in the weight of each particle will result in a reduced need of energy input to sufficiently cause a disturbance of the particle upon opening of the container. Therefore, the act of opening the container will cause sufficient disturbance of the powdered nutritional and dietary supplement.

The size of a particle can be determined by methods known within the art. Methods for particle size determination which may be employed are for example, e.g., sieves, sedimentation, electrozone sensing (Coulter counter), microscopy, and/or Low Angle Laser Light Scattering. The preferred methods for the particle size determination of the present invention are those methods which are most commonly used in the pharmaceutical industry, such as laser diffraction, e.g., via light scattering Coulter Delsa 440SX.

One aspect of the invention involves applying the fine-milling process to one or more of the ingredients. Only those ingredients that result in a reduction in particle size and a reduced weight as a result of the fine-milling process are employed for providing the desired sensory-stimulating effect.

The combined effective size and effective weight characteristics of each particle forms a ratio of an effective particle density such that the desired effect is achievable, thus forming suitable particle characteristics.

Substances having said suitable particle characteristics may be selected from those generally considered as nutritional and dietary supplement excipients. Alternatively, or in combination with said excipients, substances having suitable characteristics to achieve the desired effect may be those considered to be active ingredients in nutritional and dietary supplements. Furthermore, both medicinal and non-medicinal ingredients used in nutritional and dietary supplements may be suitable to provide the desired effect of the present invention.

The preferred nutritional and dietary supplement excipients that are employed for providing the desired sensory-stimulating effect include, but not limited to L-arginine base, L-leucine powder, creatine monohydrate and maltodextrin. According to one embodiment said excipients are provided in a ratio of about 9 parts L-arginine base to 110 parts of the total compositional mass, of about 1 part L-leucine powder to 22 parts of the total compositional mass, of about 1 part creatine monohydrate to 88 parts of the total compositional mass, and of about 5 parts maltodextrin to 22 parts of the total compositional mass.

Additionally acceptable nutritional and dietary supplement ingredients may include, but are not limited to aspartame, silicon dioxide, cellulose and derivatives thereof, starches such those from corn, oats, wheat and rice and derivatives thereof, silica and derivatives thereof, creatinol and derivatives thereof, alanine and derivatives thereof, methionine and derivatives thereof, phenylalanine and derivatives thereof, tryptophan and derivatives thereof, lysine and derivatives thereof, glutamine and derivatives thereof, glutamic acid and derivatives thereof, serine and derivatives thereof, proline and derivatives thereof, valine and derivatives thereof, isoleucine and derivatives thereof, cysteine and derivatives thereof, tyrosine and derivatives thereof, histidine and derivatives thereof, arginine and derivatives thereof, asparagine and derivatives thereof, asparatic acid and derivatives thereof, threonine and derivatives thereof, citrulline and derivatives thereof, ketoacids and derivatives thereof, ketoisocaproic acid, ketoisovaleric acid, alpha ketoglutarate, whey protein and derivatives thereof, soy protein isolate, alpha lipoic acid and derivatives thereof, corosolic acid and derivatives thereof, chromium polynicotinate, niacin.

### Sensory-Stimulating Effect

In one embodiment of the present invention, a container comprising a composition of one or more ingredients is provided to a user. At least a one ingredient contained within the composition having received the fine-milling process resulting in a fine-milled powder. The fine-milled ingredients are included in the composition in a sufficient quantity such that upon opening the container a disbursement of a plurality of the fine-milled powder particles achieved, thus contributing to the effect.

The ingredients provided in the composition as a fine-milled powder are selected from a group of ingredients which because of the fine-milling process are of an effective size and effective weight to produce the disbursement of a plurality of the fine-milled powder particles upon opening. According to one aspect of invention the fine-milled particles are provided in a sufficient quantity and in a sufficient concentration such that the particles are disturbed by air currents generated from the opening the container. Additionally, the sufficient quantity and sufficient concentration of fine-milled particles results in the repetitive ability to produce the desired sensory-stimulation each time the container is opened.

According to an embodiment of the invention, the removal of the containers closing means in a substantially outward direction, relative the container, at an effective velocity results in the generation of partial vacuum inside the container. As the relative atmospheric pressures equilibrate, both internal and external of the vessel an air current is generated. Owing to the effective size and effective weight of the fine-milled particle, the resultant air current is sufficient to cause the release and disbursement of a portion of the fine-milled particles belonging to the nutritional or dietary supplement mass. The release of said particles produces a visual effect having a sensory-stimulating effect of substantially uniform appearance wherein the particles are randomly dispersed. The visual effect is apparent to a user as a vapor-like, smoke-like, cloud-like, fog-like, or mist-like formation.

According to another embodiment, the inside of the container has an atmospheric pressure greater than that of the external side of the container, Upon opening the container, the internal atmospheric pressure is released as the relative internal and external atmospheric pressure equilibrate and a current of air is thus generated. Owing the properties of the fine-milled particles, their respective size and weight, the generated air current is sufficient so as to cause the fine-milled particles to be disrupted in a substantially uniform and randomly-dispersed visual effect. The visual effect providing sensory-stimulation is apparent both internal to the container and external to the container and most preferably about the opening of said container. The visual effect is apparent to a user as a vapor-like, smoke-like, cloud-like, fog-like, or mist-like formation.

The resultant sensory-stimulation effect evokes one or all of an individual's perception modalities. The sensory-stimulation may thus stimulate an individual's given receptive fields and evoke the signal transduction of a sensory receptor causing neuronal impulse generation and conduction integration at the central nervous system such that sensation and perception of the stimulus is achieved.

Although the preceding description illustrates the practice of the present invention in several embodiments, the embodiments should not be taken as limiting the scope of the invention. Other embodiments will be apparent to those skilled in the art from consideration of the specification of the following example.

What is claimed:

1. A method of producing a sensory-stimulating effect of a composition comprising:
supplying, in a closed container said composition containing one or more ingredients, wherein said one or more ingredients are in a powdered format, having an effective particle size, and having an effective particle weight, wherein said one or more ingredients are present in an amount sufficient to produce a substantially uniform and randomly-dispersed visual effect;
opening said closed container and releasing a plurality of particles of said one or more ingredients into the atmosphere and producing said substantially uniform and randomly-dispersed visual effect; and
whereby the release of said plurality of particles is a result of said effective particle size, said effective particle weight, an internal container atmospheric pressure and an external container atmospheric pressure.

2. The method of claim 1 wherein, said substantially uniform or randomly dispersed visual effect occurs each time said closed container is opened.

3. The method of claim 1 wherein, said substantially uniform or randomly dispersed visual effect occurs without shaking and disturbing said composition prior to opening said closed container.

4. The method of claim 1 wherein, said internal container has an atmospheric pressure greater than the atmospheric pressure external to said container.

5. The method claim 1 wherein, the opening of said container includes removing a closing means whereby a partial vacuum inside said container is generated.

6. The method of claim 5 wherein, said partial vacuum generates an air current upon pressure equilibrium inside said container.

7. The method of claim 1 wherein, said effective particle size is from about 2 to about 50 microns.

8. The method of claim 1 wherein, said visual effect is a vapor-like appearance.

9. The method of claim 1 wherein, said visual effect is a smoke-like appearance.

10. The method of claim 1 wherein, said visual effect is a cloud-like appearance.

11. The method of claim 1 wherein, said visual effect is a fog-like appearance.

12. The method of claim 1 wherein, said visual effect is a mist-like appearance.

13. The method of claim 1 wherein said one or more ingredients further comprises a first color such that said substantially uniform and randomly-dispersed visual effect is released as said first color.

14. The method of claim 1 further comprising a scent such that said visual effect is released with said scent.

15. The method of claim 14 wherein said scent is menthol.

16. A method of producing a sensory-stimulating effect of a composition comprising:
supplying, in a closed container said composition containing one or more ingredients, wherein said one or more ingredients are in a powdered format, having an effective particle size, and having an effective particle weight wherein said one or more ingredient are present in an amount sufficient to produce a substantially uniform and randomly-dispersed olfactory effect;
opening said closed container and releasing a plurality of particles of said one or more ingredients into the atmosphere and producing said substantially uniform and randomly-dispersed olfactory effect; and
whereby the release of said plurality of particles is a result of said effective particle size, said effective particle weight, an internal container atmospheric pressure and an external container atmospheric pressure.

17. The method of claim 16 wherein said olfactory effect is a menthol scent.

18. The method of claim 16 wherein said olfactory effect is a pine scent.

19. The method of claim 16 wherein said olfactory effect is a cinnamon scent.

20. The method of claim 16 wherein said olfactory effect is a vanilla scent.

21. The method of claim 16 wherein said olfactory effect is a strawberry scent.

22. The method of claim 16 wherein said olfactory effect is a chocolate scent.

23. The method of claim 16 wherein said olfactory effect is a citrus scent, wherein said citrus scent is selected from one or more species belong to the citrus genus.

24. The method of claim 16 wherein olfactory effect scent is a fruit-punch scent.
